(19) United States
(12) Patent Application Publication
(10) Pub. No.: US 2003/0090336 A1
(43) Pub. Date: May 15, 2003

(54) Adjustable coupler

(76) Inventors: Piotr Olgierd Radzikowski, Chicago, IL (US); Nicholas D. Lazzaro, Algonquin, IL (US)

Correspondence Address: MARSHALL, GERSTEIN & BORUN, 6300 Sears Tower, 233 South Wacker Drive, Chicago, IL, 60606-6357, US

(21) Appl. No.: 10/002,905

(22) Filed: Nov. 15, 2001

(51) Int. Cl. H01P 1/20

(52) U.S. Cl. 333/100; 333/203

(57) ABSTRACT

An adjustable coupler for adjusting coupling between resonant elements of a filter includes an adjustment mechanism rotatively mounted to a filter housing and an isolation element fixed to the adjustment mechanism and disposed within the filter housing. The adjustable coupler further includes a conductive element having ends proximate resonant element of the filter. When the adjustment element is rotated with respect to the housing, the proximity of the ends of the conductive element to the resonant elements changes, thereby altering the coupling between the resonant elements.

### TECHNICAL FIELD

The present invention is directed generally to electromagnetic couplers and, more particularly, to adjustable couplers for use in electromagnetic filters.

### BACKGROUND

Electromagnetic filters employing resonators are useful in many applications such as, for example, communication systems. Such filters are used to isolate certain frequency bands of interest by passing an input signal through numerous resonators, which may be disposed within separate cavities.

In some arrangements, various ones of the resonators may be coupled or cross coupled to one another. Coupling resonators refers to passing electromagnetic energy between two resonators that are disposed in series. In contrast, cross coupling resonators refers to coupling resonators that are not disposed in series. Coupling and cross coupling are commonly achieved using apertures or windows in the resonator cavities that allow electromagnetic energy to be exchanged between the resonators through the apertures. To reduce or otherwise adjust the coupling magnitude between two resonators, tuning screws may be inserted into an aperture that separates the resonators.

One drawback associated with coupling resonators through an aperture is that while the coupling between the two resonators may be reduced by introducing tuning screws into the aperture, the coupling between the two resonators may never be increased beyond the coupling that exists when no tuning screws are disposed within the aperture. Additionally, because tuning screws are typically threaded through the grounded housing, currents induced on the tuning screws by electromagnetic energy passing through the aperture are shunted to ground, thereby causing heating and quality factor (Q) degradation.

### SUMMARY

According to a first embodiment, the present invention may be an adjustable coupler for use in coupling electromagnetic energy between first and second resonant elements that are disposed within a housing. The coupler may include an adjustment mechanism having a first end disposed outside of the housing, wherein the adjustment mechanism extends through the housing and a second end of the adjustment mechanism is disposed within the housing. Additionally, the coupler may include an isolation element fixed to the second end of the adjustment mechanism and a conductive element fixed to the isolation element and positioned substantially perpendicular to the adjustment mechanism. In such an arrangement, the conductive element comprises a first end proximate to the first resonant element and a second end proximate to the second resonant element.

According to a second embodiment, an electromagnetic filter may include a housing defining first and second cavities separated from one another by a wall having a window therein, a first resonant element disposed within the first cavity and a second resonant element disposed within the second cavity. The filter may also include an adjustment mechanism having a first end disposed outside of the housing, wherein the adjustment mechanism extends through the housing and a second end of the adjustment mechanism is disposed within the window, an isolation element fixed to the second end of the adjustment mechanism and disposed partially within the window and a conductive element fixed to the isolation element and positioned substantially perpendicular to the adjustment mechanism. In such an arrangement, the conductive element may include a first end extending into the first cavity and into proximity with the first resonant element and a second end extending into the second cavity and into proximity with the second resonant element.

According to a third embodiment, an electromagnetic filter may include a housing defining first and second cavities separated from one another by a wall having a window therein and first and second resonant elements disposed in the first and second cavities. The filter may also include a conductive adjustment mechanism threaded into the housing, wherein the adjustment mechanism comprises a first end disposed outside of the housing. In such an arrangement, the adjustment mechanism extends through the housing and a second end of the adjustment mechanism is disposed within the window. A dielectric element may be fixed to the second end of the adjustment mechanism and disposed partially within the window. A conductive element may be fixed to the dielectric element and positioned substantially perpendicular to the adjustment mechanism, wherein the conductive element comprises a first end extending into the first cavity and into proximity with the first resonant element and a second end extending into the second cavity and into proximity with the second resonant element. In this arrangement, a first distance between the first end of the conductive element and the first resonant element is substantially identical to a second distance between the second end of the conductive element and the second resonant element.

The features and advantages of the present invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is an exemplary trimetric view of an electromagnetic filter having its front cover removed;

FIG. 2 is a front elevational view of the electromagnetic filter of FIG. 1;

FIG. 3 is a fragmentary cross-sectional view taken along lines 3-3 of FIG. 2;

FIG. 4 is a detailed view of a first embodiment of an adjustable coupler;

FIG. 5 is a cross-sectional view taken along lines 5-5 of FIG. 4;

FIG. 6 is a cross-sectional view of a second embodiment of an adjustable coupler;

FIG. 7 is a detailed view of a third embodiment of an adjustable coupler; and

FIG. 8 is a detailed view of a fourth embodiment of an adjustable coupler.

### DETAILED DESCRIPTION

As disclosed in detail hereinafter, an adjustable coupler may be used to control the magnitude of coupling between resonant elements in an electromagnetic filter. The adjustable coupler disclosed herein is advantageous because it provides a wider coupling tuning range between resonant elements than is provided by conventional screw and aperture coupling mechanisms. Additionally, the adjustable coupler disclosed herein provides superior Q and heating performance as compared to conventional screw and aperture coupling mechanisms because, as disclosed in detail below, the conductive element is electrically isolated from the ground potential filter housing. The adjustable coupler may be used to adjustably cross couple energy between resonant elements that are not directly in series or may be used to adjustably couple energy between series resonant elements.

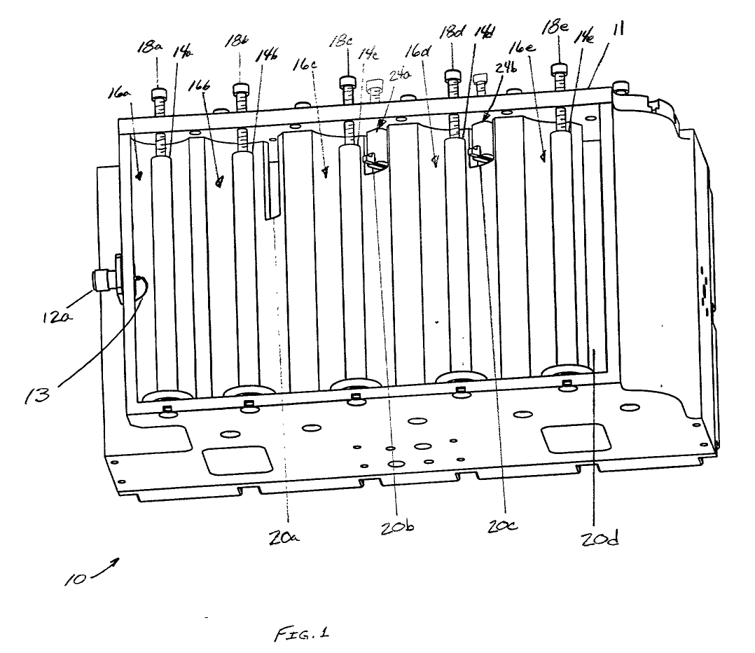

Turning now to FIGS. 1-3, an exemplary electromagnetic filter 10 having ten poles is shown. As will be readily appreciated, the fact that the filter 10 includes ten poles is merely illustrative of the inventive principles disclosed herein and, therefore should not be considered as limiting, but as merely exemplary. The filter 10 includes a housing 11, which is typically grounded, and two input/output ports 12a and 12b that couple electromagnetic signals into and out of the filter 10 via couplers 13, which may be, for example, grounded portions of conductor used to launch magnetic waves into the filter 10. For ease of explanation and to reveal components within the filter 10, the front of the housing 11 of the filter 10 is not shown.

Inside the filter 10 are disposed a number of resonant elements 14a-14j (hereinafter collectively referred to using reference numeral 14), which are located within cavities 16a-16j (hereinafter collectively referred to using reference numeral 16), respectively, that are formed in the housing 11. The resonant elements 14 may be rod or tube type resonators that may be fabricated from, for example, silver plated stainless steel that is coated with a high temperature superconductive (HTS) material such as, for example, yttrium barium copper oxide (YBCO). If HTS materials are used, the filter 10 may be cooled to roughly 77° K. Alternatively, the resonant elements 14 may not be superconducting at all. Either way, the resonant elements 14 may be connected to the housing at one end and may be an open circuit at the other end. As will be readily appreciated by those having ordinary skill in the art, the magnetic fields on the resonant elements 14 are highest at the ends of the resonant elements 14 that are connected to the housing and the electric fields on the resonant element 14 are highest at the open circuit ends of the resonant elements 14. Further detail regarding the fabrication and use of a filter 10 including rod or tube-type resonant elements similar to those shown in FIGS. 1-3 is available in a commonly-owned, co-pending patent application entitled “Dip Coating of YBCO Films on Three Dimensional Substrates” that was filed on Mar. 6, 2001 and was assigned Ser. No. 09/799,781, which is hereby expressly incorporated by reference.

Tuning elements 18a-18j (hereinafter collectively referred to using reference numeral 18), which may be embodied in conductive screws, are threaded into the housing 11 and extend into proximity with the resonant elements 14a-14j, respectively. As will be readily appreciated, the tuning elements 18-18j enable tuning of the resonant frequencies of the resonant elements 14a-14j, respectively, which, in turn, allows for the adjustment of the frequency response of the filter 10.

As shown in FIGS. 1-3, the housing 11 includes a number of apertures or windows 20a-20d (hereinafter collectively referred to using reference numeral 20) that allow coupling and cross coupling between various ones of the resonant elements 14. In particular, the windows 20a-20d allow for coupling between resonant elements 14b and 14i, 14c and 14h, 14d and 14g and 14e and 14f, respectively.

Of interest in FIGS. 1-3 are the adjustable couplers 24a and 24b, which are disposed within the windows 20b and 20c, respectively. The adjustable couplers 24a and 24b (hereinafter collectively referred to using reference numeral 24) allow cross coupling adjustment between resonant elements 14c and 14h and resonant elements 14d and 14g, respectively.

In general as described in detail in connection with FIGS. 4-8, the adjustable coupler 24 includes an adjustment mechanism 30, an isolation element 32 and a conductive element 34. The conductive element 34, which is fixed in a substantially perpendicular orientation to the adjustment mechanism, has two ends, each of which is associated with and proximate to an open circuit end of a resonant element.

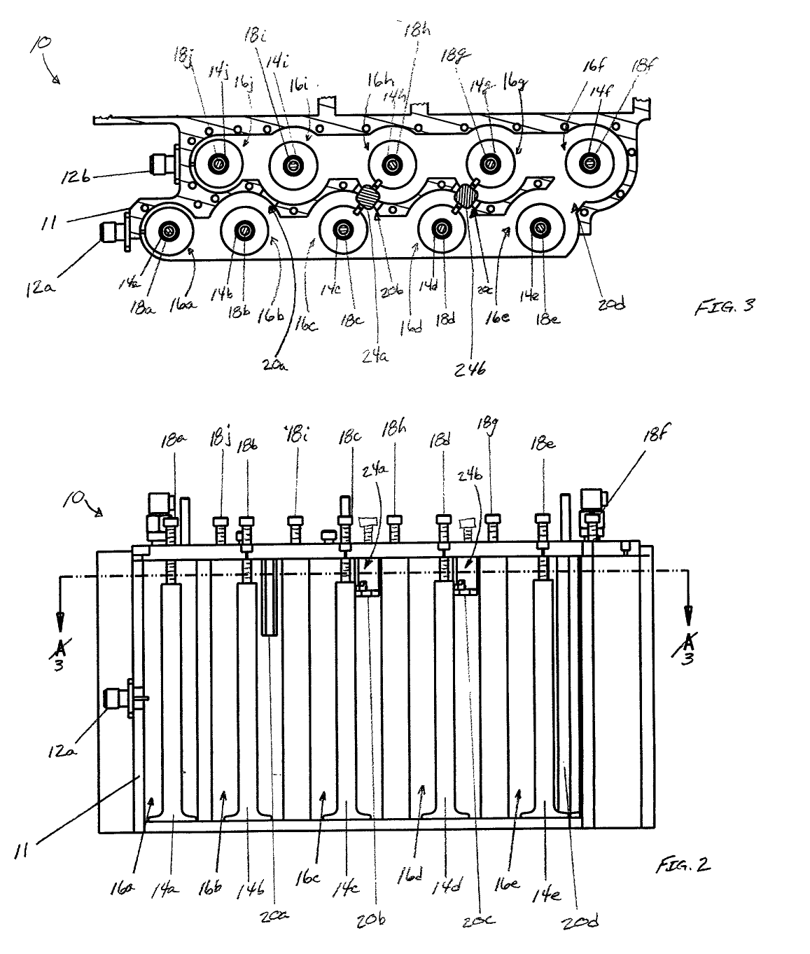

The adjustment mechanism 30 has a first end disposed outside the housing and a second end that extends into the housing and may be disposed within a window that separates two resonant elements that are to be coupled. The adjustment mechanism 30 is rotatively mounted in the housing 11 (e.g., screwed into the housing, mounted in a bushing disposed in the housing, etc.) so that when the adjustment mechanism 30 is rotated, the isolation and conductive elements 32, 34 move with respect to the resonant elements 14. As the ends of the conductive elements 34 move closer to their associated resonant elements 14, the coupling between the resonant elements 14 increases due to the close proximity of the ends of the conductive elements 34 to their associated resonant elements. Conversely, as the conductive elements 34 move farther from their associated resonant elements 14, the coupling between the resonant elements 14 decreases. As shown in FIG. 3, the conductive elements 34 are located such that as the adjustment mechanism 30 is rotated, the distances between the ends of the conductive elements 34 and their associated resonators may remain substantially equal. For example, first and second ends of the conductive element may each be 5 millimeters (mm) from their respective associated resonant element before tuning. Continuing with the example, when the coupling between those resonant elements is adjusted by moving the ends of the conductive element closer to the resonant elements, the first and second ends may each be 2 mm from their respective associated resonant elements. Alternatively, the arrangement of the adjustable coupler 24 and the resonant elements 14 may be such that the distances between the ends of the conductive elements 34 and their respective resonant elements 14 may not be substantially equal.

In general, during operation of the filter 10, electromagnetic energy flows either from port 12a to port 12b or from port 12b to port 12a, depending on how the filter 10 is connected in a circuit. For example, as energy flows from port 12a to port 12b, it traverses a path past resonant elements 14a-14e, is coupled through the window 20d to resonant element 14f and further coupled from the resonant element 14f through 14g-14j and to the port 12b. As the energy traverses the resonant elements 14, certain frequency components of the energy are suppressed or filtered. In the arrangement of FIG. 3, windows 20a-20c provide cross coupling, which is coupling between resonant elements 14 that are not consecutive along the path from port 12a to port 12b. Conversely, because the window 20d couples resonant elements 14e and 14f, which are in series, the window 20d is not referred to as providing cross coupling. Although the adjustable couplers 24 are shown as providing cross coupling in FIGS. 1-3, it should be noted that such an illustration is merely exemplary and that the adjustable couplers 24 could readily be used to adjust coupling between consecutive or series resonant elements 14.

Turning now to FIGS. 4 and 5, the adjustable coupler 24 includes the adjustment mechanism 30, which may be a screw, a rod or any other suitable structure that can be rotatively mounted into the housing 11. The adjustment mechanism 30 may be fabricated from conductive or dielectric material. A first end of the adjustment mechanism 30 may include a tool receptacle 31 adapted to receive an adjustment tool such as, for example, an Allen wrench or a screwdriver tip.

A second end of the adjustment mechanism 30 is fixed to the isolation element 32, which may be embodied in any suitable dielectric material such as, for example, Ultem®, which is a plastic dielectric that is commercially available from General Electric. In practice the isolation element 32 may be shaped to have a circular or square cross-section or may have any other suitable cross-section. The adjustment mechanism 30 may be fixed to the isolation element 32 by threads, by adhesive, by any suitable combination of the two or by any other suitable means.

Adjacent the isolation elements 32 is the conductive element 34, which may include ears 36 that protrude from the isolation element 32. The ears 36 are placed in proximity to resonant elements 14 when the adjustable coupler 24 is installed into a filter 10. A conductive link 38 provides an electrical connection between resonators 14 via the ears 36 so that electromagnetic energy may be transferred between the ears 36. The ears 36 and the conductive link 38 may be fabricated from, for example, silver plated stainless steel, which may or may not be coated with a superconductive material. Although the conductive link 38 is shown as passing through the isolation element 32, it should be noted that the conductive link 38 may be fixed externally to the isolation element 32 by glue, epoxy resin or by any other suitable fastening technique.

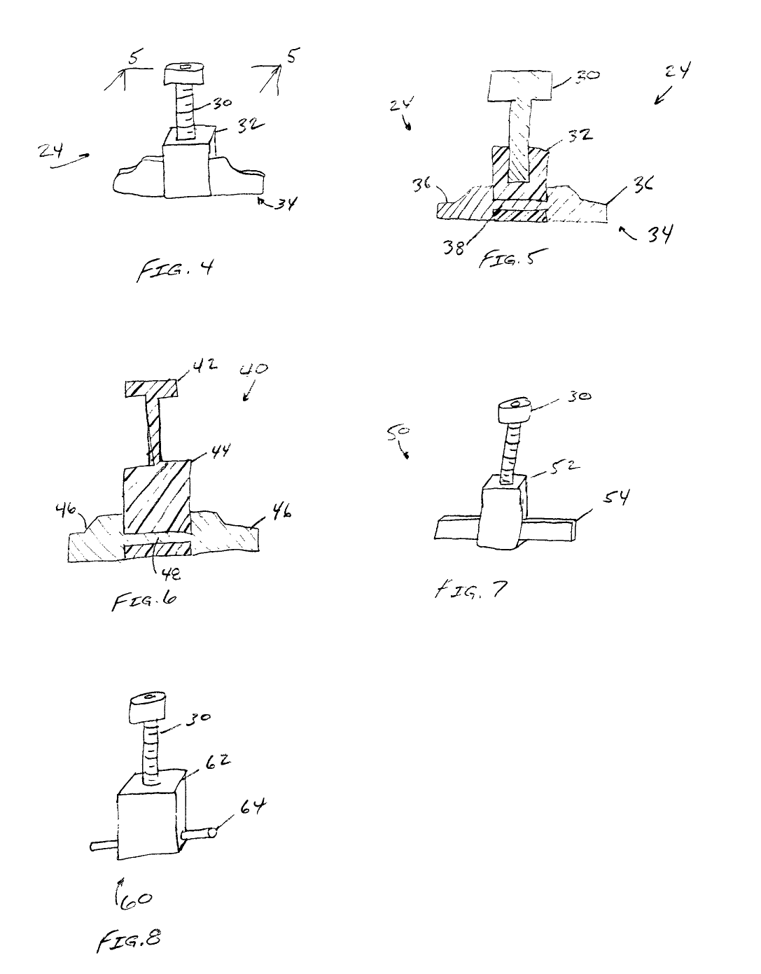

As shown in a cross-sectional view in FIG. 6, of a second embodiment of the adjustable coupler 40, may include a unitary adjustment mechanism 42 and a isolation element 44 that are fabricated together from a single portion of dielectric material such as, for example, Ultem®. Ears 46 and a conductive link 48 could then pass through or be fixed to the isolation element 44 in a manner similar or identical to that described in connection with FIGS. 4 and 5.

FIG. 7 illustrates a third embodiment of an adjustable coupler 50, which includes the adjustment mechanism 30, an isolation element 52 and a conductive element 54. The embodiment of FIG. 7 differs from the previously-described embodiments in that the conductive element 54 may be fabricated from a block of conductive material having a significant thickness or may be embodied in a band or ribbon of conductive material having a very slight thickness.

As a further alternative embodiment, FIG. 8 illustrates an adjustable coupler 60 differing from the embodiment of FIGS. 4 and 5 in that the isolation element 62 accommodates and retains a substantially cylindrically shaped conductive element 64. The conductive element 64 may be embodied in a wire, a rod, a tube or any other suitable substantially cylindrical configuration.

While numerous embodiments of the adjustable coupler are described in conjunction with FIGS. 4-8, it should be noted that such embodiments are only exemplary and that various other configurations or combinations of adjustment mechanism, isolation elements and conductive elements may be realized. For example, the substantially cylindrical conductive element 64 of FIG. 8 could be used in conjunction with the dielectric adjustment mechanism 42 and conductive element 44 of FIG. 6. The selection of the physical configuration of the conductive element will be based largely on the degree of coupling needed between resonant elements and the magnitude of the power to be coupled between resonant elements. For example, if a high degree of coupling is needed, a long conductive element may be selected so that the ends thereof are in close proximity to the resonant elements when the adjustable tuner is tuned for a high degree of coupling. Additionally, if a high degree of coupling is desired, conductive elements having large surface areas may be selected. As will be readily appreciated by those having ordinary skill in the art, the more power the conductive element is to couple between resonant elements, the larger the cross-sectional area of the conductive element should be.

Furthermore, although the conductive elements shown in FIGS. 4-8 are depicted as being substantially linear and equal in length, it would be possible or desirable to use conductive elements having bends therein or to use conductive elements having ears that are not identical in length. However, even if the conductive elements are bent, the bends in the conductive elements may be such that the ends of the conductive elements remain identical distances from their associated resonators regardless of the rotational position of the adjustment mechanism.

Each of the configurations of FIGS. 4-8 has advantages over conventional screw and aperture coupling mechanisms. For example, the adjustable coupler provides a wide coupling tuning range between resonant elements. Additionally, the adjustable coupler provides superior Q and heating performance when compared to conventional screw and aperture coupling mechanisms because the conductive element is electrically isolated from the ground potential filter housing by the isolation element, thereby preventing any currents induced on the conductive element from being grounded to the filter housing 11.

As detailed to a certain extent herein, numerous modifications and alternative embodiments of the invention will be apparent to those skilled in the art in view of the foregoing description. For example, it is possible to use the adjustable coupler to couple or cross couple resonant elements having physical configurations different from those shown in FIGS. 1-3. This description is to be construed as illustrative only, and is for the purpose of teaching those skilled in the art the best mode of carrying out the invention. Accordingly, the details of the structure and method disclosed herein may be varied substantially without departing from the spirit of the invention, and the exclusive use of all modifications that come within the scope of the appended claims is reserved.

We claim:

1. For use in coupling electromagnetic energy between first and second resonant elements that are disposed within a housing, an adjustable coupler comprising:
an adjustment mechanism having a first end disposed outside of the housing, wherein the adjustment mechanism extends through the housing and a second end of the adjustment mechanism is disposed within the housing;
an isolation element fixed to the second end of the adjustment mechanism; and
a conductive element fixed to the isolation element and positioned substantially perpendicular to the adjustment mechanism, wherein the conductive element comprises a first end proximate to the first resonant element and a second end proximate to the second resonant element.

2. The adjustable coupler of claim 1, wherein the adjustment mechanism is rotatively mounted into the housing.

3. The adjustable coupler of claim 2, wherein the adjustment mechanism is threaded into the housing.

4. The adjustable coupler of claim 2, wherein the adjustment mechanism comprises a conductor.

5. The adjustable coupler of claim 2, wherein the conductive element comprises a substantially cylindrical conductor.

6. The adjustable coupler of claim 2, wherein the conductive element comprises a band of conductive material.

7. The adjustable coupler of claim 2, wherein the isolation element comprises a dielectric material.

8. The adjustable coupler of claim 2, wherein the first and second ends of the conductive element move with respect to the first and second resonant elements when the adjustment mechanism is rotated with respect to the housing.

9. The adjustable coupler of claim 2, wherein a first distance between the first end of the conductive element and the first resonant element is substantially identical to a second distance between the second end of the conductive element and the second resonant element.

10. The adjustable coupler of claim 2, wherein the first resonant element is in series with the second resonant element.

11. The adjustable coupler of claim 2, wherein the first resonant element is not in series with the second resonant element and the adjustable coupler provides cross coupling between the first and second resonators.

12. The adjustable coupler of claim 2, wherein the first and second resonant elements comprise a high temperature superconductor material.

13. An electromagnetic filter, comprising:
a housing defining first and second cavities separated from one another by a wall having a window therein;
a first resonant element disposed within the first cavity;
a second resonant element disposed within the second cavity;
an adjustment mechanism having a first end disposed outside of the housing, wherein the adjustment mechanism extends through the housing and a second end of the adjustment mechanism is disposed within the window;
an isolation element fixed to the second end of the adjustment mechanism and disposed partially within the window; and
a conductive element fixed to the isolation element and positioned substantially perpendicular to the adjustment mechanism, wherein the conductive element comprises a first end extending into the first cavity and into proximity with the first resonant element and a second end extending into the second cavity and into proximity with the second resonant element.

14. The electromagnetic filter of claim 13, wherein the adjustment mechanism is rotatively mounted into the housing.

15. The electromagnetic filter of claim 14, wherein the adjustment mechanism is threaded into the housing.

16. The electromagnetic filter of claim 14, wherein the adjustment mechanism comprises a conductor.

17. The electromagnetic filter of claim 14, wherein the conductive element comprises a substantially cylindrical conductor.

18. The electromagnetic filter of claim 14, wherein the conductive element comprises a ribbon of conductive material.

19. The electromagnetic filter of claim 14, wherein the isolation element comprises a block of dielectric material.

20. The electromagnetic filter of claim 14, wherein the first and second ends of the conductive element move with respect to the first and second resonant elements when the adjustment mechanism is rotated with respect to the housing.

21. The electromagnetic filter of claim 14, wherein a first distance between the first end of the conductive element and the first resonant element is substantially identical to a second distance between the second end of the conductive element and the second resonant element.

22. The electromagnetic filter of claim 14, wherein the first resonant element is in series with the second resonant element.

23. The electromagnetic filter of claim 14, wherein the first resonant element is not in series with the second resonant element and the adjustable coupler provides cross coupling between the first and second resonators.

24. The electromagnetic filter of claim 14, wherein the first and second resonant elements comprise a high temperature superconductor material.

25. An electromagnetic filter, comprising:
a housing defining first and second cavities separated from one another by a wall having a window therein;
a first resonant element disposed within the first cavity;
a second resonant element disposed within the second cavity;
a conductive adjustment mechanism threaded into the housing, wherein the adjustment mechanism comprises a first end disposed outside of the housing, wherein the adjustment mechanism extends through the housing and a second end of the adjustment mechanism is disposed within the window;
a dielectric element fixed to the second end of the adjustment mechanism and disposed partially within the window; and
a conductive element fixed to the dielectric element and positioned substantially perpendicular to the adjustment mechanism, wherein the conductive element comprises a first end extending into the first cavity and into proximity with the first resonant element and a second end extending into the second cavity and into proximity with the second resonant element, and wherein a first distance between the first end of the conductive element and the first resonant element is substantially identical to a second distance between the second end of the conductive element and the second resonant element.

26. The electromagnetic filter of claim 25, wherein the conductive element comprises a substantially cylindrical conductor.

27. The electromagnetic filter of claim 25, wherein the conductive element comprises a ribbon of conductive material.

28. The electromagnetic filter of claim 25, wherein the first and second ends of the conductive element move with respect to the first and second resonant elements when the adjustment mechanism is rotated with respect to the housing.

29. The electromagnetic filter of claim 25, wherein the dielectric element comprises Ultem.

30. The electromagnetic filter of claim 25, wherein the first resonant element is in series with the second resonant element.

31. The electromagnetic filter of claim 25, wherein the first resonant element is not in series with the second resonant element and the adjustable coupler provides cross coupling between the first and second resonators.

32. The electromagnetic filter of claim 25, wherein the first and second resonant elements comprise a high temperature superconductor material.
